(19) United States
(12) Patent Application Publication
(10) Pub. No.: US 2026/0286543 A1
(43) Pub. Date: Sep. 24, 2026

(54) MEMBRANE ELECTRODE ASSEMBLY AND WATER ELECTROLYSIS CELL

(71) Applicant: Greenerity GmbH, Alzenau, DE (US)

(72) Inventors: Daniel Göhl, Mainhausen (DE); Jan Byrknes, Bad Vilbel (DE); Jens-Peter Suchsland, Alzenau (DE); Christian Eickes, Frankfurt am Main (DE); Alessandro Ghielmi, Frankfurt am Main (DE); Bernd Nollmann, Langenselbold (DE)

(73) Assignee: Greenerity GmbH, Alzenau (DE)

(21) Appl. No.: 19/469,075

(22) PCT Filed: Mar. 26, 2024
(86) PCT No.: PCT/EP2024/058102

§ 371 Date: Sep. 25, 2025

(30) Foreign Application Priority Data
Mar. 27, 2023 (DE) 10 2023 107 643.4

(51) Int. Cl. C25B 9/23; C25B 1/04; C25B 13/07; C25B 13/08

(52) U.S. Cl. CPC C25B 9/23; C25B 1/04; C25B 13/07; C25B 13/08

(57) ABSTRACT

A membrane electrode assembly for a water electrolysis cell, that includes an anode, a cathode and a hydrocarbon membrane lying between the anode and the cathode, further including a first gas recombination layer which is arranged between the anode and the hydrocarbon membrane, wherein between the gas recombination layer and the hydrocarbon membrane at least one adhesion layer is arranged, wherein the adhesion layer includes at least one ceramic material and one proton-conductive polymer.

### CROSS REFERENCE TO RELATED APPLICATIONS

This application is a US national stage filing under 35 U.S.C. § 371 of International Application No. PCT/EP2024/058102, filed Mar. 26, 2024, which claims priority to German Patent Application No. 10 2023 107 643.4, filed Mar. 27, 2023, each of which is incorporated herein by reference in its entirety.

### TECHNICAL FIELD

This disclosure relates to a membrane electrode assembly with high power density and with low membrane layer thickness, and a water electrolysis cell which comprises this membrane electrode assembly.

### BACKGROUND

Membrane electrode assemblies and, in this regard, catalyst coated membranes with a proton-exchange membrane, which on one side are coated with an anode and on the opposite side are coated with a cathode, are well-known from prior art under the term CCM (Engl.: catalyst coated membrane). In the use of the CCM in water electrolysis, the term PEM-WE (Engl.: proton-exchange membrane water electrolysis) is common.

Proton-exchange membranes for the use in PEM-WE are normally extruded perfluoro sulfonic acid-based (PFSA; Engl.: perfluoro sulfonic acid) polymer membranes. The most established examples for PEM-WE are Nafion® N115 and Nafion® N117 of the company Chemours. Furthermore, in current literature thinner, cast, i.e., by a solvent, printed membranes, such as Nafion® NR212, are used.

In the anode electrode layer (short: anode), a catalyst for the oxidation of water (water splitting) is used. This catalyst is often referred to as OER catalyst (Engl.: oxygen evolution reaction). Normally, OER catalysts are formed on the basis of noble metals and comprise noble metal oxides having a high catalytic activity for water splitting. Furthermore, normally, in the anode a proton-conductive polymer, a so-called ionomer of the PFSA type is used as binder, which is present mixed with the OER catalyst.

In the cathode electrode layer (short: cathode), a catalyst is used for the reduction of protons to hydrogen (Engl.: hydrogen evolution reaction=HER catalyst). These catalysts, normally, are based on platinum and/or palladium, wherein platinum and/or palladium are preferably present in a finely dispersed state on carbon powders. Furthermore, normally, the cathode also comprises an ionomer on the basis of PFSA as binder.

Furthermore, a membrane electrode assembly for water electrolysis cells can comprise at least one gas recombination layer, which normally comprises a recombination catalyst, such as, e.g., platinum particles. Preferably, the platinum particles are present in a finely dispersed state in an ionomer matrix, which is arranged between the anode and the membrane. The gas recombination layer can be considered as part of the membrane. The recombination catalyst catalyzes the reaction of hydrogen, which from the cathode passes over to the anode, with oxygen of the anode side to prevent the formation of explosive mixtures on the anode side of a cell. Mostly, the ionomer of the gas recombination layer due to the oxidation stability is selected from the group of perfluorinated polymers, particularly perfluorinated sulfonic acid polymers.

EP 3 559 314 A1 teaches a membrane with a laminate structure, wherein an intermediate layer comprises a recombination catalyst, which comprises platinum or palladium carried on carriers with large surface areas such as, e.g., carbon, silica, titanium oxide, or zirconium oxide. Mainly, common PFSA membranes are described.

Hydrocarbon membranes are mostly used in fuel cell uses, such as, for example, is taught in EP 1 133 806 A1.

In comparison to perfluoro sulfonic acid membranes (PFSA membranes), hydrocarbon membranes are characterized by several advantages. For example, they have a lower gas permeability through the membrane, so that higher cell current yields can be achieved, even in the case, when very thin membranes are used, resulting in a very low ion resistance (and thus a very good performance). In addition, they can be operated for a longer time at high temperatures >100° C. with limited degradation, which is the result of the low gas permeability (also at high temperature) and the high glass transition temperature being typical for hydrocarbon-based polymers. An operation at higher temperature results in several advantages of the system: reduced size of the cooling facility, lower susceptibility with respect to gas impurities and higher degree of efficiency of the cell. Hydrocarbon membranes also emit lower amounts of aggressive degradation products, e.g., HF and extremely acidic sulfonic acid molecules which are released from PFSAs, which results in a lower damaging of the metallic bipolar plates in the stack during the operation, which in turn allows a longer service life and/or the use of cheaper materials. Finally, hydrocarbon membranes in comparison to perfluorinated ionomers have an improved environmental profile because they do not contain perfluoroalkyl compounds, and no perfluoroalkyl chemistry is required during their production.

However, a disadvantage of hydrocarbon membranes is that they are characterized by a very low adhesiveness and thus adhesion to common gas recombination layers and anodes, which often comprise PFSA ionomers as binder, particularly under the wet conditions such as in the water electrolysis. This may result in peeling off of the gas recombination layer and the catalyst layers (anode and cathode), which in turn results in a lower cell performance, and which even may result in cell failures.

In this matter, generally, a transfer of construction features of a fuel cell to water electrolysis cells is not possible.

It could therefore be helpful to provide a membrane electrode assembly for a water electrolysis cell, which comprises a hydrocarbon membrane and is characterized by very good adhesion properties with respect to the gas recombination layer, so that a consistently high power density (low cell voltage also in the case of high current densities) results. It could further be helpful to provide a water electrolysis cell, which due to the use of the membrane electrode assembly is also characterized by a consistently high power density.

### SUMMARY

We thus provide a membrane electrode assembly for a water electrolysis cell, including an anode, a cathode and a hydrocarbon membrane arranged between the anode and the cathode, further including a gas recombination layer which is arranged between the anode and the hydrocarbon membrane, wherein between the gas recombination layer and the hydrocarbon membrane at least one adhesion layer is arranged, wherein the adhesion layer includes at least one ceramic material and one proton-conductive polymer.

Some embodiments provide a membrane electrode assembly, wherein the hydrocarbon membrane includes sulfonated polyether ketones, sulfonated polyether ether ketones, sulfonated polyketone ketones, sulfonated polyphenylenes, sulfonated phenylated polyphenylenes and mixtures thereof.

Some embodiments provide a membrane electrode assembly, wherein the ceramic material is selected from at least one of oxides, nitrides, carbides, silicides, borides, fluorides and mixtures thereof, of at least one, selected from silicon, tantalum, niobium, tin, titanium, zirconium, cerium, tungsten, antimony and mixtures thereof, wherein the ceramic material is particularly selected from silicon oxide, tantalum oxide, niobium oxide, tungsten oxide, and zirconium oxide, and/or wherein a specific surface area of the ceramic material, measured according to BET, is larger than 1 m²/g and smaller than 1200 m²/g, particularly larger than 50 m²/g and smaller than 800 m²/g, and particularly larger than 100 m²/g and smaller than 400 m²/g, and/or wherein the proton-conductive polymer of the adhesion layer is selected from the group of fluorinated ionomers, perfluorinated ionomers and hydrocarbon-based ionomers and combinations thereof, and it is particularly a perfluorinated proton-conductive polymer, and/or wherein the equivalent weight of the proton-conductive polymer of the adhesion layer is smaller than 1050 g/mol and particularly lower than 950 g/mol and particularly smaller than 850 g/mol.

Some embodiments provide a membrane electrode assembly, wherein a volume portion 1, wherein the gas recombination layer includes at least one proton-conductive polymer, wherein the proton-conductive polymer is particularly a fluorinated ionomer, a perfluorinated ionomer or a hydrocarbon-based ionomer, particularly a perfluorinated ionomer.

Some embodiments provide a membrane electrode assembly, further including a second adhesion layer, wherein an adhesion layer facing the hydrocarbon membrane has a lower mass portion of proton-conductive polymer than an adhesion layer facing the gas recombination layer.

Some embodiments provide a membrane electrode assembly, further including a second adhesion layer, wherein an adhesion layer facing the hydrocarbon membrane has a mass portion of proton-conductive polymer of 24 to 56% by volume, and an adhesion layer facing the gas recombination layer has a mass portion of proton-conductive polymer of 56 to 100% by volume, each based on the respective total mass of the respective adhesion layer.

Some embodiments provide a membrane electrode assembly, wherein the adhesion layer includes at least one noble metal, and the noble metal is particularly selected from the group consisting of platinum, palladium, iridium, ruthenium, rhodium, rhenium, gold as well as mixtures or alloys thereof, and is particularly platinum and/or palladium, wherein particularly the noble metal is present as alloy with copper, cobalt, nickel, iron, yttrium, and/or tin, and is particularly present as alloy with cobalt and/or nickel and particularly in the form of PtCo, PtCoNi, or PtPdCo, wherein particularly a basis weight of the noble metal in the adhesion layer is 0 to 0.1 mg/cm² and particularly 0.01 to 0.05 mg/cm², wherein particularly a mass portion of the noble metal, based on the sum of the mass of the noble metal and the ceramic material in the adhesion layer, is 0.1% by mass to 80% by mass, particularly 0.5% by mass to 30% by mass, particularly 1% by mass to 10% by mass, wherein particularly the noble metal is present carried on the ceramic material, wherein particularly the noble metal is present deposited as particles on the ceramic material, and the particle size of the ceramic material being provided with noble metal particles, measured by means of transmission electron microscopy, wherein 500 particles are analyzed, is 1 to 30 nm and particularly 2 to 6 nm.

Some embodiments provide a membrane electrode assembly, wherein a layer thickness of the adhesion layer is 0.1 to 20 μm, particularly 0.2 to 10 μm and particularly 0.5 to 2 μm.

Some embodiments provide a water electrolysis cell including a membrane electrode assembly.

### BRIEF DESCRIPTION OF THE DRAWINGS

FIG. 1 is an MEA according to a first embodiment in sectional view.

FIG. 2 is a measuring arrangement for determining the adhesion between the layers of the MEA.

FIG. 3 is a diagram, obtained by conducting the adhesion test with the measuring arrangement according to FIG. 2.

FIG. 4 is a diagram, illustrating the results of the experiments of the adhesion test of the prepared examples.

### LIST OF REFERENCE SIGNS

1 MEA
2 anode
3 cathode
4 hydrocarbon membrane
5 gas recombination layer
6 adhesion layer
7 ceramic material
8 proton-conductive ionomer
9 noble metal
10 measuring arrangement
11 adhesive tape
12 glass substrate
13 paper

### DETAILED DESCRIPTION

Provided herein is a membrane electrode assembly (MEA) which comprises an anode, a cathode and a hydrocarbon membrane lying between the anode and the cathode as well as a gas recombination layer being present between the anode and the hydrocarbon membrane. To improve the adhesiveness between the hydrocarbon membrane and the gas recombination layer, at least one adhesion layer is present between the gas recombination layer and the hydrocarbon membrane.

The membrane electrode assembly may be present as laminate of layers with the sequence of layers: anode/first gas recombination layer/adhesion layer(s)/hydrocarbon membrane/cathode. Further layers may be provided, whilst at least one adhesion layer is arranged between the gas recombination layer and the hydrocarbon membrane. The layers can be laminated with each other. In an alternative to this, the membrane electrode assembly (MEA) may be present as CCM (catalyst coated membrane), wherein the layers each are directly applied onto the hydrocarbon membrane.

The hydrocarbon membrane comprises at least one ionomer which is not fluorinated, or the content of fluorine of which is at most 5% by mass, based on the total mass of the ionomer. Thus, the hydrocarbon membrane comprises at least one hydrocarbon-based ionomer, wherein also two or more hydrocarbon-based ionomers can be present in combination. Preferably, the hydrocarbon membrane is free of substances containing fluorine.

Furthermore, one or more reinforcing structures can be incorporated into the hydrocarbon membrane, so that the reinforcing structure(s) limit(s) the expansion of the hydrocarbon membrane. A reinforcing structure, for example, can be implemented during the production process of the hydrocarbon membrane from an ionomer dispersion or ionomer solution. Thus, a previously formed reinforcing structure, such as ceramic materials or polymeric materials, such as, e.g., (bi)axially stretched PTFE (ePTFE, Engl.: expanded PTFE), or woven structures, such as, e.g., woven fabric made of polyketone (PK) fibers, polyether ketone (PEK) fibers, polyether ether ketone (PEEK) fibers, perfluoroalkoxy alkane (PFA) fibers, or polyphenylene sulfide (PPS) fibers, is impregnated with a respective ionomer dispersion and subsequently dried, so that the pores of the reinforcing structure are filled with ionomer. Subsequently, the hydrocarbon membrane can be tempered in a high temperature step, e.g., at about 150° C. to 200° C., to improve the stability of the hydrocarbon membrane. The content of fluorine of at most 5% by mass mentioned above explicitly relates to the ionomer, and not to the reinforcing structures. Also, a membrane which comprises a reinforcing structure containing fluorine, for example, made of PTFE, and a hydrocarbon ionomer is covered by the definition of a hydrocarbon membrane.

Advantageously, the hydrocarbon membrane has a layer thickness of 5 to 120 μm, particularly of 15 to 90 μm and particularly of 35 to 75 μm. In this way, an optimum balance between degree of efficiency, gas tightness and dimensional stability is achieved.

Furthermore, hydrocarbon membranes with a higher layer thickness of, e.g., up to 200 μm can be used, wherein due to the high membrane proton resistance, mainly in high current densities, a significant reduction of the degree of efficiency can occur.

The anode and the cathode, unless otherwise disclosed below, are formed for water electrolysis cells, and comprise at least one binder and at least one catalyst catalyzing the respective electrolysis reaction.

Also, the gas recombination layer, which may be present as single layer or in the form of a laminate of two or more layers, is not limited in detail, and it can be formed comprise at least one proton-conductive polymer and one recombination catalyst. The recombination catalyst, such as already explained above, catalyzes the reaction of hydrogen, which passes over from the cathode to the anode, with oxygen of the anode side, to prevent the formation of explosive mixtures on the anode side of a cell, and particularly comprises platinum particles. The ionomer of the gas recombination layer due to the oxidation stability is mostly selected from the group of perfluorinated polymers and particularly perfluorinated sulfonic acid polymers (PFSA polymers).

The adhesion layer may be present as single layer or as sequency of layers with two or more adhesion layers. The adhesion layers may be of the same design or they may have different designs. When the reference below is made to an adhesion layer, then an adhesion layer which is in direct contact with the hydrocarbon membrane is meant. Further adhesion layers can be arranged between this adhesion layer and the gas recombination layer. Unless otherwise stated in addition, the following explanations with respect to the composition and the design of the adhesion layer apply to all adhesion layers being used.

The adhesion layer in direct contact with the hydrocarbon membrane, which can also be referred to as first adhesion layer, comprises at least one ceramic material and at least one proton-conductive polymer.

The adhesion layer can also comprise two or more ceramic materials and/or two or more proton-conductive polymers.

Neither the proton-conductive polymer nor the ceramic material is limited in detail.

The ceramic material is not limited in detail, and it is present in the proton-conductive polymer(s) in a dispersed, thus distributed state. This may, e.g., be achieved by the fact that in the production of the adhesion layer an adhesion layer dispersion is prepared, in which the ceramic material and the proton-conductive polymer are sufficiently mixed, before the further processing to the adhesion layer is conducted.

Due to the (first) adhesion layer, between the hydrocarbon membrane and the gas recombination layer a high adhesion is achieved, so that even under the wet conditions of the water electrolysis no peeling off between the gas recombination layer and the hydrocarbon membrane occurs. This results in a particularly high power density of the MEA.

The hydrocarbon membrane is not limited in detail. Particularly stable hydrocarbon membranes are selected from sulfonated polyaryl ethers (SPAE), sulfonated polyaryl ether ether nitriles (SPAEEN), sulfonated polyaryl ether ketones (SPAEK), sulfonated polyaryl ether nitriles (SPAEN), sulfonated polyaryl ether sulfones (SPAES), sulfonated polyaryl ether sulfone ketones (SPAESK), sulfonated polyether ether ketones (SPEEK), sulfonated polyether ketones (SPEK), sulfonated polyether sulfones (SPES), sulfonated polyimides, sulfonated polyketone ketones (SPKK), sulfonated polyphosphazenes (SPPh), sulfonated polyphenylene sulfones (SPPSf), sulfonated polyphenylene sulfide sulfones (SPPSSf), sulfonated polyphenylene sulfide sulfone nitriles (SPPSSfN), sulfonated polystyrenes (SPS), sulfonated polysulfones (SPSf), sulfonated polyphenylenes (sPP), sulfonated phenylated polyphenylenes (sPPP) and mixtures thereof, and they are particularly selected from sulfonated polyether ketones, sulfonated polyether ether ketones, sulfonated polyketone ketones, sulfonated polyphenylenes, sulfonated phenylated polyphenylenes and mixtures thereof.

When the ceramic material is selected from at least one of oxides, nitrides, carbides, silicides, borides, fluorides and mixtures thereof, a particularly high adhesion between the hydrocarbon membrane and the gas recombination layer is obtained. In other words, so the adhesive force of the adhesion layer is improved. This is true, all the more, for oxides, nitrides, carbides, silicides, borides, fluorides and mixtures thereof of at least one, selected from chromium, molybdenum, silicon, tantalum, niobium, tin, titanium, zirconium, cerium, tungsten, antimony, aluminum and mixtures thereof. Particularly, the metals can be contained in amounts, which are normally used for doping. This also applies to the content of fluorine in the ceramic material. Due to the very good reduction stability, the ceramic material is particularly selected from silicon oxide, tantalum oxide, niobium oxide, tungsten oxide (WO₃), and zirconium oxide (ZrO₂), and it is particularly selected from Nb₂O₅, Ta₂O₅, SiO₂ and mixtures thereof.

Further advantageously, a specific surface area of the ceramic material, measured according to BET, is larger than 1 m²/g and smaller than 1200 m²/g, particularly larger than 50 m²/g and smaller than 800 m²/g, and particularly larger than 100 m²/g and smaller than 400 m²/g. The BET method is conducted according to DIN ISO 9277:2003-05 “Bestimmung der spezifischen Oberfläche von Feststoffen durch Gasadsorption nach dem BET-Verfahren”. With a specific surface area in the mentioned range and particularly in the preferred range of larger than 100 m²/g and smaller than 400 m²/g, the ceramic material is characterized by properties imparting very good adhesion.

Due to the very good proton conductivity, the proton-conductive polymer of the adhesion layer is preferably selected from the group of fluorinated ionomers, perfluorinated ionomers, hydrocarbon-based ionomers and combinations thereof, and it is particularly a perfluorinated proton-conductive polymer.

Further advantageously, in the light of an additional minimal proton resistance by the MEA, the equivalent weight of the proton-conductive polymer of the adhesion layer may be smaller than 1050 g/mol, preferably smaller than 950 g/mol and further preferably smaller than 850 g/mol. The equivalent weight is the weight of the ionomer per mol of functional groups, particularly sulfonic acid groups.

For the improvement of the adhesion properties, and thus for a reduction of the delamination or peeling off of single layers or parts of layers of the membrane electrode assembly, it is advantageous, when a volume portion of proton-conductive polymer in the adhesion layer, based on the total volume of the adhesion layer, is 24 to 84% by volume. The total volume of the adhesion layer is defined as the sum of the volumes of the single components. In higher contents of ionomers, peeling off between gas recombination layer and hydrocarbon membrane results, because the adhesion layer cannot provide sufficient adhesiveness to the hydrocarbon membrane. On the other hand, in a lower content of ionomers (lower than 24% by volume), the proton conductivity is reduced too strongly, which may result in high resistances and thus in a low performance and a poor film formation, and thus, e.g., in flaking off.

In the light of the above advantages, a volume portion of proton-conductive polymer in the adhesion layer, based on the total volume of the adhesion layer, is preferably 35 to 75% by volume and further preferably 46 to 65% by volume.

For improving the efficiency of the water electrolysis, the gas recombination layer comprises at least one proton-conductive polymer, wherein the proton-conductive polymer is particularly a fluorinated ionomer, a perfluorinated ionomer or a hydrocarbon-based ionomer, and particularly a perfluorinated ionomer.

For further improving the adhesion between the hydrocarbon membrane and the gas recombination layer, the MEA advantageously comprises a second adhesion layer which is arranged between the gas recombination layer and the first adhesion layer. For particularly increasing the adhesion properties, the first adhesion layer facing the hydrocarbon membrane has a lower volume portion of proton-conductive polymer than the second adhesion layer facing the gas recombination layer.

Furthermore advantageously, in the MEA a second adhesion layer may be provided, which is arranged between the gas recombination layer and the hydrocarbon membrane. In the light of the improvement of the proton transport through the gas recombination layer as well as a good cell composite, advantageously, a volume portion of proton-conductive polymer in the first adhesion layer facing the hydrocarbon membrane is 24 to 56% by volume. Furthermore advantageously, a volume portion of proton-conductive polymer in the second adhesion layer facing the gas recombination layer is 56 to 100% by volume, each based on the respective total volume of the respective first or second adhesion layers.

In addition to the adhesion, to improve the catalytic properties on the anode side of the MEA, particularly for increasing the hydrogen-oxygen recombination, the adhesion layer particularly comprises at least one noble metal, and the noble metal is preferably selected from the group consisting of platinum, palladium, iridium, ruthenium, rhodium, rhenium, gold as well as mixtures and alloys thereof, and it is particularly platinum and/or palladium.

When the noble metal is present in the form of an alloy, then furthermore it is preferable, when the noble metal is present as alloy with copper, cobalt, nickel, iron, yttrium, and/or tin, and particularly as alloy with cobalt and/or nickel. The alloys can be binary or also ternary or quaternary ones. Particularly advantageous alloys are PtCo, PtCoNi, and PtPdCo.

For maximizing the adhesion properties of the adhesion layer, the content of noble metal should not be too high. Advantageously, a basis weight of the noble metal in the adhesion layer is 0.01 to 0.1 mg/cm² and particularly 0.01 to 0.05 mg/cm².

Particularly in the use of PFSA ionomers in the adhesion layer, it is advantageous when a mass portion of the noble metal, based on the sum of the mass of the noble metal and the ceramic material in the adhesion layer, is 0.1% by mass to 80% by mass, particularly 0.5% by mass to 30% by mass, particularly 1% by mass to 10% by mass. Particularly by the preferred ranges, it becomes evident that the portion of ceramic material is particularly important for the improvement of the adhesion between the gas recombination layer and the hydrocarbon membrane.

For the improvement of the catalytically supporting activity of the adhesion layer, the noble metal advantageously is present carried on the ceramic material.

For further improving the homogeneity of the adhesion layer and thus also the adhesion force thereof, the noble metal is present deposited as particles on the ceramic material, and the particle size of the ceramic material being provided with noble metal particles is 1 to 30 nm and particularly 2 to 6 nm. The particle size is determined by means of transmission electron microscopy, wherein 500 particles are analyzed, for calculating an average value.

The particle size distribution can be monomodal, bimodal or multimodal. One peak may particularly be at a position of 1.5 nm, and a further one at a position of 5 nm.

To improve the balance between increased adhesion and layer thickness which should be as low as possible for reducing the own weight of the MEA, a layer thickness of the adhesion layer is preferably in a range of 0.1 to 20 μm, particularly of 0.2 to 10 μm and particularly of 0.5 to 2 μm. The layer thicknesses are measured by scanning electron microscopy.

As a further aspect, a water electrolysis cell is described, which comprises the membrane electrode assembly such as described above. Due to the use of the membrane electrode assembly, the water electrolysis cell is characterized by very good adhesive properties between the single layers and particularly between the gas recombination layer and the hydrocarbon membrane, so that also in the water electrolysis cell permanently a high efficiency is achieved.

Further details, advantages and features arise from the following description of embodiment examples with the help of the drawing. Shown is in:

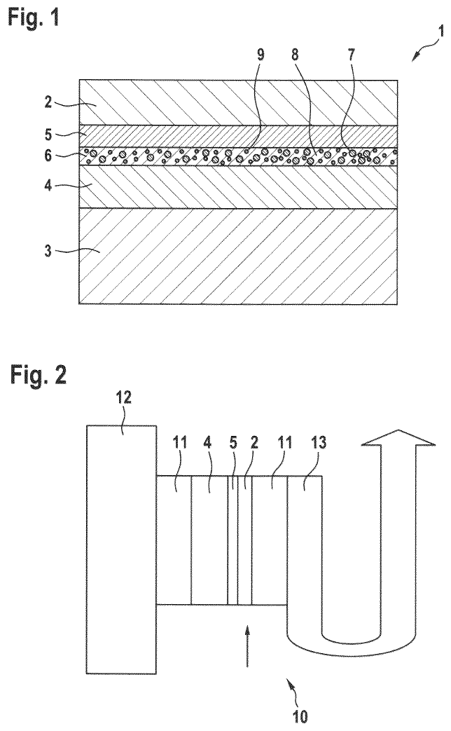

In FIG. 1 only the essential components of the MEA are shown. For the sake of clarity, all other components are omitted.

FIG. 1 shows in detail an MEA 1 which can be used for a water electrolysis cell.

The MEA 1 is shown in sectional view and comprises an anode 2, a cathode 3 and a hydrocarbon membrane 4 lying between the anode 2 and the cathode 3. Between the hydrocarbon membrane 4 and the anode 2 a gas recombination layer 5 is present. Furthermore, between the hydrocarbon membrane 4 and the gas recombination layer 5 an adhesion layer 6 for improving the adhesiveness between the hydrocarbon membrane 4 and the gas recombination layer 5 is present.

The gas recombination layer 5 serves for improving the gas purity, i.e., only a low portion of hydrogen gets to oxygen on the anode side, and/or, a low portion of oxygen gets to hydrogen on the cathode side. The gas recombination layer comprises at least one recombination catalyst which particularly comprises platinum particles. In addition, the gas recombination layer 5 comprises at least one perfluorinated ionomer, particularly one PFSA ionomer.

The anode 2 serves for the oxidation of water, and for this it comprises an OER catalyst (Engl.: oxygen evolution reaction), which is formed from noble metals and may comprise noble metal oxides, which have a high catalytic activity for the water splitting. Due to the very good catalytic activity and the stability with respect to dissolution during the operation, iridium- and ruthenium-containing OER catalysts such as, for example, iridium oxide, ruthenium oxide or a mixed iridium-ruthenium oxide are preferred. Furthermore, the anode 2 comprises at least one proton-conductive polymer, a so-called ionomer of the PFSA type, which is used as binder and is present mixed with the OER catalyst.

The cathode 3 is used for the reduction of protons to hydrogen, and for this it comprises an HER catalyst (Engl.: hydrogen evolution reaction=HER catalyst). This HER catalyst is based on platinum and/or palladium, wherein platinum and/or palladium, preferably, is/are present on carbon powders in a finely dispersed state. Furthermore, the cathode 3 also comprises a PFSA-based ionomer as binder.

In this embodiment the adhesion layer 6 is arranged between the hydrocarbon membrane 4 and the gas recombination layer 5, and particularly it has a layer thickness of 0.1 to 20 μm. The adhesion layer 6 comprises at least one ceramic material 7 and at least one proton-conductive polymer 8 and optionally one noble metal 9. Also, two or more noble metals 9 and/or two or more ceramic materials 7 and/or two or more proton-conductive polymers 8, which are particularly fluorinated ionomers and particularly perfluorinated ionomers, can be contained in the adhesion layer 6.

The noble metal 9 is particularly selected from the group consisting of platinum, palladium, iridium, ruthenium, rhodium, rhenium, gold as well as mixtures and alloys thereof, and it is particularly platinum and/or palladium. When the noble metal 9 is present as alloy, then it is particularly an alloy with copper, cobalt, nickel, iron, yttrium, and/or tin. A basis weight of the noble metal 9 in the first gas recombination layer 5 is particularly 0.01 to 0.05 mg/cm², but it may also be 0 mg/cm². When two or more noble metals 9 are used, then the basis weight relates to the basis weight of the sum of all noble metals 6.

The ceramic material 7 is particularly selected from at least one of oxides, nitrides, carbides, silicides, borides, fluorides and mixtures thereof, of at least one, selected from chromium, molybdenum, silicon, tantalum, niobium, tin, titanium, zirconium, cerium, tungsten, antimony, aluminum and mixtures thereof. Particularly suitable are silicon oxide, tantalum oxide, niobium oxide, tungsten oxide (WO₃), and zirconium oxide (ZrO₂).

Preferably, the ceramic material 7 has a specific surface area, measured according to BET, of larger than 1 m²/g and smaller than 1200 m²/g.

Preferably, a mass portion of the noble metal 9, based on the sum of the mass of the noble metal 9 and the ceramic material 7 in the adhesion layer 6, is 0.1% by mass to 80% by mass, particularly 0.5% by mass to 30% by mass and particularly 1% by mass to 10% by mass.

Advantageously, the noble metal 9 is present carried on the ceramic material 7. Particularly, the noble metal 9 is deposited as particles on the ceramic material 7, and the particle size of the ceramic material 7 being provided with noble metal particles is 1 to 30 nm and particularly 2 to 6 nm.

As already mentioned, the membrane is a hydrocarbon membrane 4. Thus, it is mainly formed of one or more hydrocarbon-based ionomers, such as, e.g., sulfonated polyaryl ethers (SPAE), sulfonated polyaryl ether ether nitriles (SPAEEN), sulfonated polyaryl ether ketones (SPAEK), sulfonated polyaryl ether nitriles (SPAEN), sulfonated polyaryl ether sulfones (SPAES), sulfonated polyaryl ether sulfone ketones (SPAESK), sulfonated polyether ether ketones (SPEEK), sulfonated polyether ketones (SPEK), sulfonated polyether sulfones (SPES), sulfonated polyimides, sulfonated polyketone ketones (SPKK), sulfonated polyphosphazenes (SPPh), sulfonated polyphenylene sulfones (SPPSf), sulfonated polyphenylene sulfide sulfones (SPPSSf), sulfonated polyphenylene sulfide sulfone nitriles (SPPSSfN), sulfonated polystyrenes (SPS), sulfonated polysulfones (SPSf), sulfonated polyphenylenes (sPP), sulfonated phenylated polyphenylenes (sPPP) and mixtures thereof, and the portion of fluorine, based on the total mass of the ionomer of the hydrocarbon membrane 4, is at most 5% by mass.

Hydrocarbon ionomers may be linear polymers, cross-linked polymers, branched polymers, grafted polymers and/or block polymers. Optionally, they may also contain hetero atoms such as F, N, S, and P. Block copolymers containing sulfonic acid-rich blocks alternately with sulfonic acid-poor or non-sulfonated blocks are particularly advantageous with respect to the combination of high proton conductivity, good mechanical properties and high dimensional stability.

According to the present embodiment, the adhesion layer 6 considerably improves the adhesion between the hydrocarbon membrane 4 and the gas recombination layer 5, so that a very good layer composite is obtained. The very good adhesion is achieved by the fact that the adhesion layer comprises at least one ceramic material distributed in at least one proton-conductive polymer. In this way, the adhesion layer 6 acts in a mediating manner between the hydrocarbon membrane and the gas recombination layer containing PFSA ionomer, so that no delamination or defects occur, even under the wet conditions, such as they prevail in the water electrolysis.

The equivalent weight of the proton-conductive polymer (8) of the adhesion layer is smaller than 1050 g/mol and particularly smaller than 950 g/mol and particularly smaller than 850 g/mol, so that also in the case of a limited amount of ionomer a sufficient number of proton-conductive sulfonic acid groups is present, and thus the protective layer in total has a high proton conductivity.

In the light of an improvement of the adhesion, the volume portion of proton-conductive polymer in the adhesion layer 6 is particularly 24 to 84% by volume and particularly 35 to 75% by volume.

The membrane electrode assembly can be prepared as follows.

For the preparation of an adhesion layer dispersion, a ceramic material and an ionomer containing fluorine are ground together in a ball mill (grinding medium: ZrO₂ balls). The grinding time is, e.g., 120 minutes and depends on the dispersibility of the ceramic material. So, the grinding time can generally be adapted accordingly.

In an alternative or in addition, for the preparation of a dispersion also ultrasonics or different grinding body mills can be used. Grinding body mills are, e.g., ball mills, agitator bead mills, agitator mills, attritors and specific rolling mills.

In a further method step, the adhesion layer dispersion is applied onto an anode (incl. gas recombination layer) or a hydrocarbon membrane. Generally, the application method is not limited. As application methods, common technologies such as, e.g., slit dies, doctor blades, spiral applicators, screen printing or spraying facilities are used.

Subsequently, the adhesion layer dispersion was dried, wherein an adhesion layer on the anode (incl, the gas recombination layer) or the hydrocarbon membrane was obtained.

When the adhesion layer dispersion is applied onto the anode, then in a further method step a lamination of the anode provided with the adhesion layer and the hydrocarbon membrane may be conducted. The lamination temperature may be 150 to 190° C., and a pressure may be 1 to 3 MPa. The lamination time may be about one minute.

The above procedural method is also used when the adhesion layer dispersion is applied onto the hydrocarbon membrane. Then, a lamination with the anode incl. gas recombination layer is conducted.

This first method using common technologies can easily be implemented and allows the production of an MEA with high adhesion and gas purity.

According to a second method, the production of the MEA, at first, comprises again the preparation of an adhesion layer dispersion which can be conducted such as explained for the first method. The adhesion layer dispersion in turn comprises at least one ceramic material and at least one ionomer containing fluorine.

Subsequently, the adhesion layer dispersion is applied onto a substrate. The substrate with respect to the adhesion layer dispersion is inert, thus do not show chemical or physical reactivity in connection with the adhesion layer dispersion.

In a further method step, the adhesion layer dispersion is dried, wherein the adhesion layer is prepared, and thus a so-called decal is obtained.

Then, the adhesion layer is transferred onto the anode incl. gas recombination layer or onto the hydrocarbon membrane, and subsequently the substrate is removed.

Depending on whether the adhesion layer has been transferred onto the anode incl. gas recombination layer or onto the hydrocarbon membrane by the decal method, furthermore a lamination with either a hydrocarbon membrane or an anode incl. gas recombination layer may be conducted, such as described above for the first method.

Also, this second method can easily be implemented using common technologies and allows the production of an MEA with high adhesion and gas purity.

According to a third method, as described above, an adhesion layer dispersion is prepared, which comprises at least one ceramic material and at least one ionomer containing fluorine.

Furthermore, an anode dispersion and a gas recombination layer dispersion are prepared. The anode dispersion and the gas recombination layer dispersion respectively comprise particularly at least one catalytically active substance, such as explained for the MEA.

Then, a further decal method is conducted, by first applying the anode dispersion, then the gas recombination layer dispersion and then the adhesion layer dispersion onto the dispersion which has been applied onto the substrate and onto the previously applied dispersion, respectively. Thus, a layer assembly results: substrate/anode dispersion/gas recombination layer dispersion/adhesion layer dispersion.

The dispersions are dried. It is not necessary to follow a particular order. E.g., at first, the anode dispersion can be dried, before the gas recombination layer dispersion and the adhesion layer dispersion are applied, or the gas recombination layer dispersion and the adhesion layer dispersion are applied onto the anode dispersion which is still not dried, and all three dispersions are dried at the same time, wherein the anode layer, the gas recombination layer dispersion and the adhesion layer on the substrate are prepared.

Then, the decal, thus the dried anode layer/gas recombination layer dispersion/adhesion layer-assembly is transferred onto the hydrocarbon membrane, so that the adhesion layer is arranged between hydrocarbon membrane and gas recombination layer.

By the third method, the production of an MEA with high adhesion and gas purity using common technologies is possible easily.

Subsequently to the above method steps of the third method, a step of laminating the anode layer/gas recombination layer dispersion/adhesion layer-assembly and the hydrocarbon membrane may be conducted, such as already described for the first and second methods.

According to a fourth method, as described above, an adhesion layer dispersion is prepared, which comprises at least one ceramic material and at least one ionomer containing fluorine.

Furthermore, an anode dispersion and a gas recombination layer dispersion are prepared. The anode dispersion and the gas recombination layer dispersion respectively particularly comprise at least one catalytically active substance, such as described for the MEA.

Then, the adhesion layer dispersion is applied onto the hydrocarbon membrane, and subsequently, at first, the gas recombination layer dispersion and then the anode dispersion are applied onto the adhesion layer dispersion.

Furthermore, a drying of the dispersions is conducted, wherein the anode layer, the gas recombination layer and the adhesion layer are prepared, wherein the dispersions can be dried one after the other or together.

Subsequently to all methods which are disclosed above, a further method step of tempering in a temperature range of 150 to 200° C. can be conducted, for strengthening the mechanic properties of the adhesion layer. Optionally, this step can coincide with one of the decal methods.

The production of the MEA according to the methods can easily be realized with high production rates with techniques and equipment, which are already used in the production of water electrolysis cell membrane electrode assemblies.

### EXAMPLES

An anode catalyst ink was prepared by mixing of an iridium oxide catalyst in water, solvents and a D79-25BS PFSA ionomer dispersion from Solvay Specialty Polymers. The catalyst/ionomer ratio was 9.7:1. The anode catalyst ink was ground for 120 minutes in a ball mill (grinding medium: ZrO₂ balls having a diameter of 1 mm). An anode catalyst layer was prepared by applying the catalyst ink onto a substrate and drying (decal method).

For the preparation of the gas recombination dispersion, 0.25 g of a platina black, 21.67 g of D2020 (The Chemours Company, PFSA ionomer dispersion, 20.9% by mass), 3.54 g of water and 44.54 g of organic solvents were mixed and ground for 120 minutes in a ball mill (grinding medium: ZrO₂ balls having a diameter of 1 mm). This corresponded with a mass portion of the ionomer of 95% by mass, and accordingly with a volume portion of the ionomer of 99.5% by volume. The conversion is conducted via the density of the platinum of 21.45 g/cm³ and the density of the ionomer of 2.1 g/m³. Subsequently, the edge of the anode was circumferentially covered with a frame of a 50 μm thick PET foil, and with the help of a spiral doctor blade (wire diameter 30 μm) it was overlaid with the gas recombination dispersion and dried for 5 minutes at 120° C. in a furnace. The resulting basis weight of platinum was 0.17 mg/cm². The thickness of the gas recombination layer was about 3 μm.

A cathode catalyst ink was prepared by mixing of a Pt/C (60% by mass of Pt on carbon) catalyst, water, solvents and a D2020 PFSA ionomer dispersion from The Chemours Company. The ionomer/carbon ratio was 0.8:1. The cathode catalyst ink was ground for 120 minutes in a ball mill (grinding medium: ZrO₂ balls having a diameter of 1 mm). A cathode catalyst layer was prepared by applying the catalyst ink onto a substrate and drying (decal method).

Catalyst coated membranes (CCM) were prepared from anode catalyst layers, which contained an iridium oxide catalyst without a carrier with an iridium load of 2.25 mgₗᵣ/cm² and which, optionally, were overlaid with a gas recombination layer. Cathode catalyst layers contained a catalyst with 60% by mass of Pt on carbon with a platinum load of 0.80 mg Pt/cm². Then, catalyst coated membranes (CCMs) were prepared by means of a decal method (standard transfer decal method), wherein an ionomer membrane was arranged between an anode layer/gas recombination layer-assembly and on the other side of the membrane opposite cathode layer. The lamination was conducted at a temperature of 160° C. and a pressure of 3 MPa for 1 minute, and subsequently the substrates (decal) were removed. The active surface of both catalyst layers was 50 mm×50 mm, and the membrane size was 80 mm×80 mm.

Table 1 summarizes the CCM compositions.

### Production of the Adhesion Layers

### Example 1

For the production of the adhesion layer, 0.38 g of silicon dioxide, 7.18 g of D2020 (The Chemours Company, PFSA ionomer dispersion, 20.9% by mass), 4.97 g of water and 39.65 g of organic solvents were mixed and ground for 120 minutes in a ball mill (grinding medium: ZrO₂ balls having a diameter of 1 mm). The mass ratio of the ceramic material to ionomer was 2:8. This was equivalent to a volume portion of the ionomer of 83.5% by volume. The conversion is conducted via the density of the silicon dioxide of 2.65 g/cm³ and the density of the ionomer of 2.1 g/m³. Subsequently, the edge of the anode was circumferentially covered with a frame of a 50 μm thick PET foil, and with the help of a spiral doctor blade (wire diameter 30 μm) it was overlaid with the adhesion layer dispersion and dried for 5 minutes at 120° C. in a furnace.

### Example 2

For the production of the adhesion layer, 0.64 g of silicon dioxide, 7.18 g of D2020 (The Chemours Company, PFSA ionomer dispersion, 20.9% by mass), 4.97 g of water and 39.65 g of organic solvents were mixed and ground for 120 minutes in a ball mill (grinding medium: ZrO₂ balls having a diameter of 1 mm). The mass ratio of the ceramic material to ionomer was 3:7. This was equivalent to a volume portion of the ionomer of 74.6% by volume. The conversion is conducted via the density of the silicon dioxide of 2.65 g/cm³ and the density of the ionomer of 2.1 g/m³. Subsequently, the edge of the anode was circumferentially covered with a frame of a 50 μm thick PET foil, and with the help of a spiral doctor blade (wire diameter 30 μm) it was overlaid with the adhesion layer dispersion and dried for 5 minutes at 120° C. in a furnace. The thickness of the gas recombination layer was about 3 μm.

### Example 3

For the production of the adhesion layer, 1.00 g of silicon dioxide, 7.18 g of D2020 (The Chemours Company, PFSA ionomer dispersion, 20.9% by mass), 4.97 g of water and 39.65 g of organic solvents were mixed and ground for 120 minutes in a ball mill (grinding medium: ZrO₂ balls having a diameter of 1 mm). The mass ratio of the ceramic material to ionomer was 4:6. This was equivalent to a volume portion of the ionomer of 65.4% by volume. The conversion is conducted via the density of the silicon dioxide of 2.65 g/cm³ and the density of the ionomer of 2.1 g/m³. Subsequently, the edge of the anode was circumferentially covered with a frame of a 50 μm thick PET foil, and with the help of a spiral doctor blade (wire diameter 30 μm) it was overlaid with the adhesion layer dispersion and dried for 5 minutes at 120° C. in a furnace. The thickness of the gas recombination layer was about 3 μm.

### Example 4

For the production of the adhesion layer, 1.50 g of silicon dioxide, 7.18 g of D2020 (The Chemours Company, PFSA ionomer dispersion, 20.9% by mass), 4.97 g of water and 39.65 g of organic solvents were mixed and ground for 120 minutes in a ball mill (grinding medium: ZrO₂ balls having a diameter of 1 mm). The mass ratio of the ceramic material to ionomer was 5:5. This was equivalent to a volume portion of the ionomer of 55.8% by volume. The conversion is conducted via the density of the silicon dioxide of 2.65 g/cm³ and the density of the ionomer of 2.1 g/m³. Subsequently, the edge of the anode was circumferentially covered with a frame of a 50 μm thick PET foil, and with the help of a spiral doctor blade (wire diameter 30 μm) it was overlaid with the adhesion layer dispersion and dried for 5 minutes at 120° C. in a furnace. The thickness of the gas recombination layer was about 3 μm.

### Example 5

For the production of the adhesion layer, 2.25 g of silicon dioxide, 7.18 g of D2020 (The Chemours Company, PFSA ionomer dispersion, 20.9% by mass), 4.97 g of water and 39.65 g of organic solvents were mixed and ground for 120 minutes in a ball mill (grinding medium: ZrO₂ balls having a diameter of 1 mm). The mass ratio of the ceramic material to ionomer was 6:4. This was equivalent to a volume portion of the ionomer of 45.7% by volume. The conversion is conducted via the density of the silicon dioxide of 2.65 g/cm³ and the density of the ionomer of 2.1 g/m³. Subsequently, the edge of the anode was circumferentially covered with a frame of a 50 μm thick PET foil, and with the help of a spiral doctor blade (wire diameter 30 μm) it was overlaid with the adhesion layer dispersion and dried for 5 minutes at 120° C. in a furnace. The thickness of the gas recombination layer was about 3 μm.

### Comparative Example 1 and Comparative Example 2

The catalyst coated membrane of the Comparative Example 1 and Comparative Example 2 does not comprise a gas recombination layer and an adhesion layer.

### Comparative Example 3 and Comparative Example 4

The catalyst coated membrane of the Comparative Example 3 and Comparative Example 4 comprises a gas recombination layer according to the above-mentioned composition and does not comprise an adhesion layer.

### Comparative Example 5

For the production of the adhesion layer, 0.17 g of silicon dioxide, 7.18 g of D2020 (The Chemours Company, PFSA ionomer dispersion, 20.9% by mass), 4.97 g of water and 39.65 g of organic solvents were mixed and ground for 120 minutes in a ball mill (grinding medium: ZrO₂ balls having a diameter of 1 mm). The mass ratio of the ceramic material to ionomer was 1:9. This was equivalent to a volume portion of the ionomer of 91.9% by volume. The conversion is conducted via the density of the silicon dioxide of 2.65 g/cm³ and the density of the ionomer of 2.1 g/m³. Subsequently, the edge of the anode was circumferentially covered with a frame of a 50 μm thick PET foil, and with the help of a spiral doctor blade (wire diameter 30 μm) it was overlaid with the adhesion layer dispersion and dried for 5 minutes at 120° C. in a furnace. The thickness of the gas recombination layer was about 3 μm.

### CCM Production (Membrane Electrode Assemblies)

Anode and adhesion layers were prepared according to the above description. For the production of the CCM, a PFSA membrane Nafion N115 (The Chemours Company, United States) or a hydrocarbon membrane Fumasep FKE-50 (Fumatech GmbH, Germany) having a thickness of 50 μm according to the table was used.

| | | Gas | | |
|---|---|---|---|---|
| | | recombination | | |
| Example | Ionomer content | layer | Membrane | Adhesion |
| Example 1 | 83.5% by volume | Yes | Hydrocarbon FKE-50 | Medium |
| Example 2 | 74.6% by volume | Yes | Hydrocarbon FKE-50 | Good |
| Example 3 | 65.4% by volume | Yes | Hydrocarbon FKE-50 | Good |
| Example 4 | 55.8% by volume | Yes | Hydrocarbon FKE-50 | Good |
| Example 5 | 45.7% by volume | Yes | Hydrocarbon FKE-50 | Good |
| Comparative Example 1 | Not present | Not present | PFSA Nafion N115 | Good |
| Comparative Example 2 | Not present | Not present | Hydrocarbon FKE-50 | Good (because |
| | | | | no GRC) |
| Comparative Example 3 | Not present | Yes | Nafion N115PFSA | Good |
| Comparative Example 4 | Not present | Yes | Hydrocarbon FKE-50 | Poor |
| Comparative Example 5 | 91.9% by volume | Yes | Hydrocarbon FKE-50 | Poor (too much |
| | | | | ionomer) |

The adhesion force was determined by a measuring arrangement 1 such as shown in FIG. 2. For this, each half MEA (MEA without cathode) with the membrane side 4 with an adhesive tape 11 was arranged on a glass substrate 12. In addition, a paper 13 (printer paper, 80 g/m²) was fixed at the anode 2 with the help of an adhesive tape 11. The paper 13 was longer than the half MEA, and it was clamped in the measuring instrument such that it was able to serve as traction strap. Then, in the direction of the arrow a traction was applied. When the traction force reaches the adhesion or cohesion force of one layer used in the half MEA, then a plateau is reached, and the layer is delaminated with constant force. The adhesion force results as average value over the length of the plateau divided by the sample width. The sample width was 2 cm.

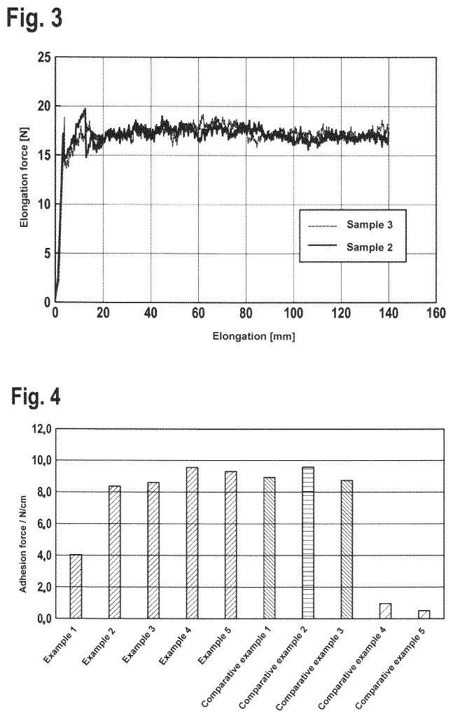

FIG. 3 shows exemplarily by the measuring arrangement of FIG. 2 obtained measured curves for the Comparative Example 1. Different samples of the Comparative Example 1 were measured, and arbitrarily the measured curves of sample 2 and sample 3 were shown in FIG. 3. At about 17 to 18 N, the plateau is reached, and thus a delamination. In the case of a sample width of 2 cm, thus about 9 N/cm are achieved, such as shown in FIG. 4 for comparative example 5.

From the elongation force which was measured in Newton, the adhesion force was calculated in N/cm. An overview of the adhesion forces of the above examples is shown in FIG. 4. It was shown that MEAs are characterized by a very good adhesion between membrane, adhesion layer and gas recombination layer/anode-assembly.

Furthermore, the examples show that the advantage of an adhesion layer becomes only necessary, when a gas recombination layer is used, because MEAs without a gas recombination layer (Comparative Examples 1 and 2) do not have adhesion problems, but, however, they do not show improved gas purity. MEAs with a gas recombination layer with a hydrocarbon membrane, but without adhesion layer, however, show a low adhesion (Comparative Example 4). On the contrary, a PFSA membrane does not need an additional adhesion layer, and already shows good adhesion to a gas recombination layer. (Comparative Example 3).

From the elongation force which was measured in Newton, the adhesion force was calculated in N/cm. An overview of the adhesion forces of the above examples is shown in FIG. 4.

It is shown that the MEA 1 has very good adhesion forces due to the adhesion layer 6 used.

In addition to the above disclosure, for its supplemental disclosure herewith, explicitly, reference is made to the graphic representation in FIGS. 1 to 4.

1. A membrane electrode assembly for a water electrolysis cell, comprising an anode, a cathode and a hydrocarbon membrane arranged between the anode and the cathode, further comprising a gas recombination layer which is arranged between the anode and the hydrocarbon membrane, wherein between the gas recombination layer and the hydrocarbon membrane at least one adhesion layer is arranged, wherein the adhesion layer comprises at least one ceramic material and one proton-conductive polymer.

2. The membrane electrode assembly according to claim 1, wherein the hydrocarbon membrane comprises sulfonated polyether ketones, sulfonated polyether ether ketones, sulfonated polyketone ketones, sulfonated polyphenylenes, sulfonated phenylated polyphenylenes and mixtures thereof.

3. The membrane electrode assembly according to claim 1, wherein the ceramic material is selected from at least one of oxides, nitrides, carbides, silicides, borides, fluorides and mixtures thereof, of at least one, selected from silicon, tantalum, niobium, tin, titanium, zirconium, cerium, tungsten, antimony and mixtures thereof, wherein the ceramic material is particularly selected from silicon oxide, tantalum oxide, niobium oxide, tungsten oxide, and zirconium oxide, and/or
wherein a specific surface area of the ceramic material, measured according to BET, is larger than 1 m²/g and smaller than 1200 m²/g, particularly larger than 50 m²/g and smaller than 800 m²/g, and particularly larger than 100 m²/g and smaller than 400 m²/g, and/or
wherein the proton-conductive polymer of the adhesion layer is selected from the group of fluorinated ionomers, perfluorinated ionomers and hydrocarbon-based ionomers and combinations thereof, and it is particularly a perfluorinated proton-conductive polymer, and/or
wherein the equivalent weight of the proton-conductive polymer of the adhesion layer is smaller than 1050 g/mol and particularly lower than 950 g/mol and particularly smaller than 850 g/mol.

4. The membrane electrode assembly according to claim 1, wherein a volume portion of the proton-conductive polymer in the adhesion layer, based on the total volume of the adhesion layer, is 24 to 84% by volume, particularly 35 to 75% by volume and particularly 46 to 65% by volume.

5. The membrane electrode assembly according to claim 1, wherein the gas recombination layer comprises at least one proton-conductive polymer, wherein the proton-conductive polymer is particularly a fluorinated ionomer, a perfluorinated ionomer or a hydrocarbon-based ionomer, particularly a perfluorinated ionomer.

6. The membrane electrode assembly according to claim 1, further comprising a second adhesion layer, wherein an adhesion layer facing the hydrocarbon membrane has a lower mass portion of proton-conductive polymer than an adhesion layer facing the gas recombination layer.

7. The membrane electrode assembly according to claim 1, further comprising a second adhesion layer, wherein an adhesion layer facing the hydrocarbon membrane has a mass portion of proton-conductive polymer of 24 to 56% by volume, and an adhesion layer facing the gas recombination layer has a mass portion of proton-conductive polymer of 56 to 100% by volume, each based on the respective total mass of the respective adhesion layer.

8. The membrane electrode assembly according to claim 1, wherein the adhesion layer comprises at least one noble metal, and the noble metal is particularly selected from the group consisting of platinum, palladium, iridium, ruthenium, rhodium, rhenium, gold as well as mixtures or alloys thereof, and is particularly platinum and/or palladium, wherein
particularly the noble metal is present as alloy with copper, cobalt, nickel, iron, yttrium, and/or tin, and is particularly present as alloy with cobalt and/or nickel and particularly in the form of PtCo, PtCoNi, or PtPdCo, wherein
particularly a basis weight of the noble metal in the adhesion layer is 0 to 0.1 mg/cm² and particularly 0.01 to 0.05 mg/cm², wherein
particularly a mass portion of the noble metal, based on the sum of the mass of the noble metal and the ceramic material in the adhesion layer, is 0.1% by mass to 80% by mass, particularly 0.5% by mass to 30% by mass, particularly 1% by mass to 10% by mass, wherein
particularly the noble metal is present carried on the ceramic material, wherein
particularly the noble metal is present deposited as particles on the ceramic material, and the particle size of the ceramic material being provided with noble metal particles, measured by means of transmission electron microscopy, wherein 500 particles are analyzed, is 1 to 30 nm and particularly 2 to 6 nm.

9. The membrane electrode assembly according to claim 1, wherein a layer thickness of the adhesion layer is 0.1 to 20 μm, particularly 0.2 to 10 μm and particularly 0.5 to 2 μm.

10. A water electrolysis cell comprising a membrane electrode assembly according to claim 1.
